(19) United States
(12) Patent Application Publication
(10) Pub. No.: US 2014/0314314 A1
(43) Pub. Date: Oct. 23, 2014

(54) SYSTEMS AND METHODS FOR QUANTIFYING GRAPHICS OR TEXT IN AN IMAGE

(71) Applicant: CANON KABUSHIKI KAISHA, Tokyo (JP)

(72) Inventors: Attaullah Seikh, Irvine, CA (US); Don Purpura, Yorba Linda, CA (US)

(73) Assignee: CANON KABUSHIKI KAISHA, Tokyo (JP)

(21) Appl. No.: 13/868,535

(22) Filed: Apr. 23, 2013

(51) Int. Cl. G06K 9/62

(52) U.S. Cl. CPC G06K 9/62
USPC 382/165; 382/194

(57) ABSTRACT

Systems and methods for evaluating a quantity of text in an image determine rows in an image that include spikes, wherein determining that a row includes a spike includes determining that a difference between the value of an earlier pixel in the row and a subsequent adjacent pixel exceeds a first threshold, and determining that a difference between a value of a later pixel in the row that is within a first predetermined range of the earlier pixel and a value of a pixel subsequent to the later pixel exceeds the first threshold; determine a number of hits in the image, wherein determining a hit includes determining that a number of rows within a predetermined row range each include a spike; determine if the number of hits exceeds a second threshold; and select an image encoder based on whether or not the number of hits exceeds the threshold.

### BACKGROUND

1. Field

The present disclosure generally relates to the quantification of graphics or text in an image.

2. Background

Images may include graphics and text. For example, advertisements, brochures, and magazine pages often show graphics and text. Some technologies recognize characters in an image (e.g., Optical Character Recognition) and can be used to extract the character to determine the text in the images, but these technologies do not quantify the text and graphics in an image.

### SUMMARY

In some embodiments, a method for evaluating a quantity of text in an image comprises determining rows in an image that include spikes, wherein determining that a row includes a spike includes determining that a difference between the value of an earlier pixel in the row and a subsequent adjacent pixel exceeds a first threshold, and determining that a difference between a value of a later pixel in the row that is within a first predetermined range of the earlier pixel and a value of a pixel subsequent to the later pixel exceeds the first threshold; determining a number of hits in the image, wherein determining a hit includes determining that a number of rows within a predetermined row range each include a spike; determining if the number of hits exceeds a second threshold; and selecting an image encoder based on whether or not the number of hits exceeds the threshold.

In some embodiments, a device for evaluating an image comprises one or more computer-readable media configured to store an image; and one or more processors coupled to the one or more computer-readable media and configured to cause the device to detect a spike in a row of pixels in a region of an image, detect respective spikes in adjacent rows of pixels, register a hit if the spikes are within a predetermined row range of each other, and determine the number of hits in the region of the image.

In some embodiments, one or more computer-readable media store instructions that, when executed by one or more computing devices, cause the computing devices to perform operations comprising detecting spikes in rows of a region of an image, detecting a number of hits in the image, determining if the number of hits exceeds a second threshold, and selecting an image encoder based on whether or not the number of hits exceeds the threshold.

### BRIEF DESCRIPTION OF THE DRAWINGS

FIG. 1 illustrates an example embodiment of an image quantification system.

FIG. 2 illustrates an example embodiment of a method for quantifying an image.

FIG. 3 illustrates examples of changes in pixel values.

FIG. 4 illustrates an example embodiment of a method for quantifying an image.

FIG. 5A illustrates an example embodiment of an image quantification system.

FIG. 5B illustrates an example embodiment of an image quantification system.

FIG. 6 illustrates an example embodiment of a method for quantifying an image.

FIG. 7 illustrates example embodiments of image regions.

FIG. 8 illustrates examples of pixel values and spike detection.

### DESCRIPTION

The following disclosure describes certain explanatory embodiments. Other embodiments may include alternatives, equivalents, and modifications. The explanatory embodiments may include several novel features, and a particular feature may not be essential to some embodiments of the devices, systems, and methods described herein. Also, herein the conjunction “or” refers to an inclusive “or” instead of an exclusive “or”, unless indicated otherwise.

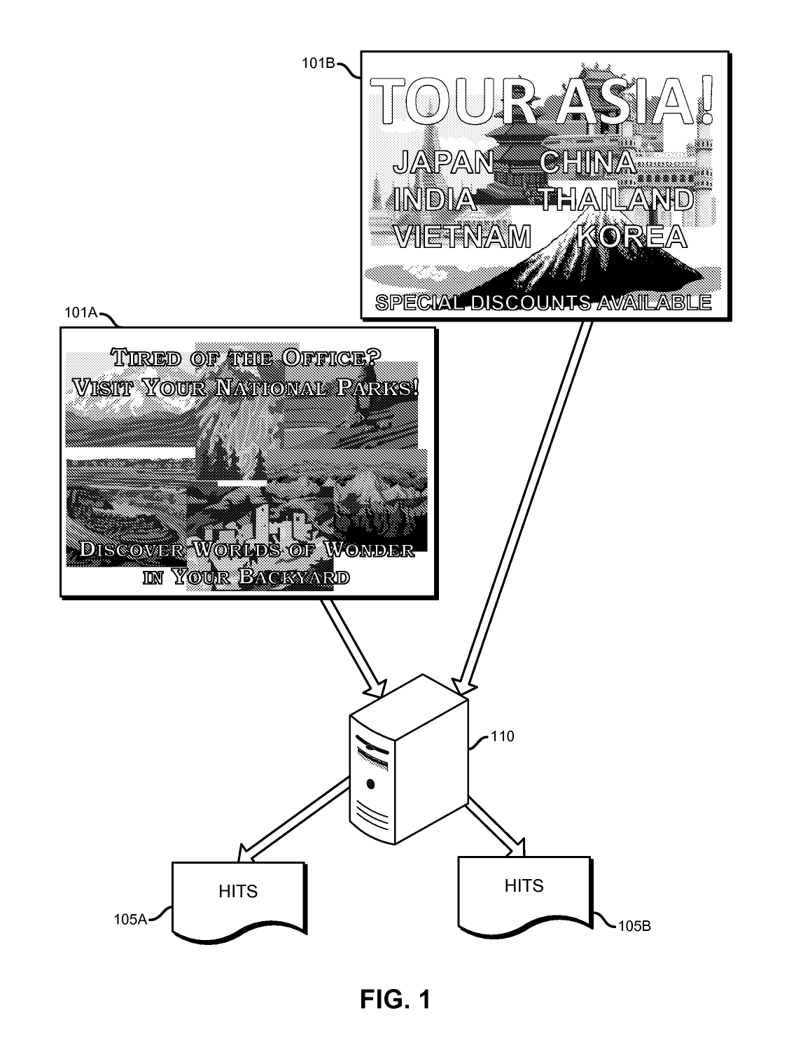

FIG. 1 illustrates an example embodiment of an image quantification system 110. The image quantification system 110 includes one or more computing devices (e.g., desktops, laptops, tablets, servers, PDAs, smart phones). The image quantification system 110 quantifies one or more of the graphics and text in images. The image quantification system 110 generates a quantification measure (e.g., a number of hits 105) for an image that indicates how much text may be in an image or that indicates the relationship between the quantity of graphics and the quantity of text in the image.

The image quantification system 110 obtains one or more images 101, such as the two example images, the first image 101A and the second image 101B. The image quantification system 110 then generates respective quantification measures, which are hits 105 in this embodiment, for each of the obtained images. Thus, in this example, the image quantification system 110 generates first hits 105A for the first image 101A and second hits 105B for the second image 101B. The image quantification system 110 may not perform any recognition of the particular characters in an image, unlike Optical Character Recognition technologies, and instead may quantify the amount of text in an image, the amount of graphics in an image, or the relative amount of text versus graphics in an image in the corresponding quantification measures (e.g., hits 105).

After generating the hits 105, the image quantification system 110 may compare the hits 105 to one or more thresholds. Based on the comparison, the image quantification system 110 may select a text encoder or a graphics encoder, may identify an image 101 as text or graphics, or may label the image 101 as text or graphics.

Additionally, the hits 105 may quantify an amount of text in an image 101 even if the image includes text that is superimposed over graphics. Detecting only a distribution of colors may not accurately reveal the presence of text in an image 101, or a part of an image 101, because the presence of graphics may produce a broad distribution of colors even if the image includes text.

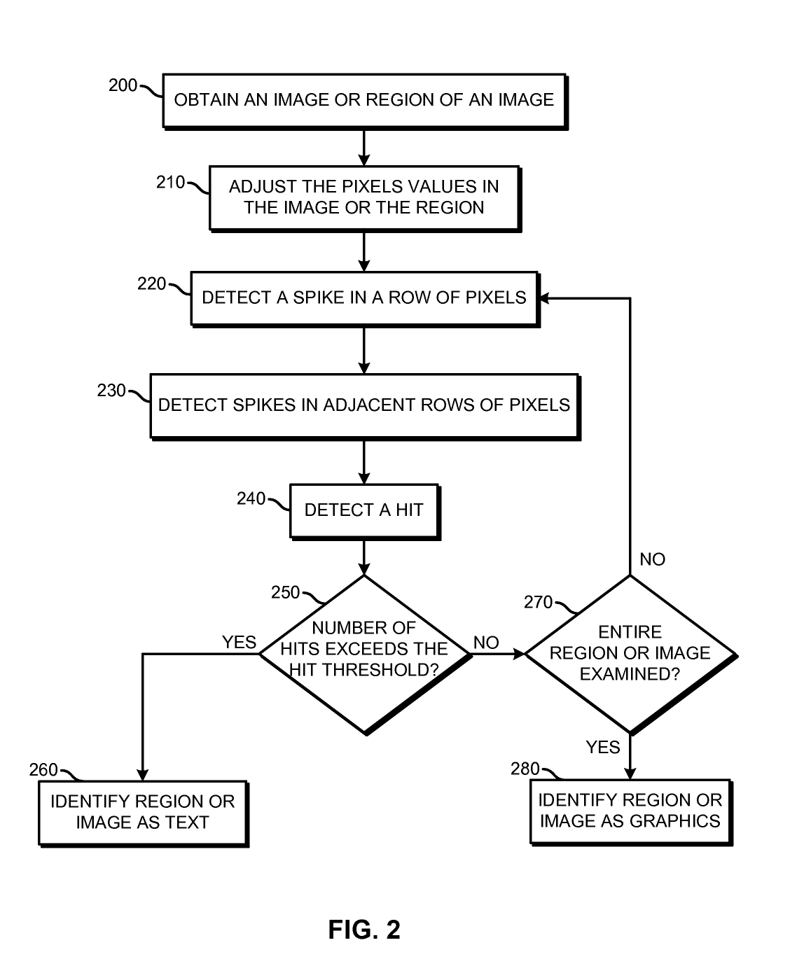

FIG. 2 illustrates an example embodiment of a method for quantifying an image. Other embodiments of this method and the other methods described herein may omit blocks, add blocks, change the order of the blocks, combine blocks, or divide blocks into separate blocks. Also, the methods described herein may be implemented by the systems and devices described herein. The flow starts in block 200, where an image or a region of an image is obtained (e.g., obtained by an image quantification device via a network interface, from storage, from memory, from a camera, from a scanner). Next, in block 210, the pixel values of the region or the image are adjusted, for example by reducing the color bit depth of the pixels or by creating one pixel value from the average of the three RGB values for a pixel. Some other embodiments of the method do not perform the operations in this block.

The flow then proceeds to block 220, where a spike is detected in a row of pixels in the image or the region of the image. Some embodiments of the method use edge detection to detect spikes, and the presence of two edges within a predetermined range of pixels is verified in order to determine that the pixels include a spike. The predetermined range of pixels within which the two edges must be found may be a configurable parameter (e.g., a “column check”).

Additionally, in some embodiments, detecting a spike includes determining that a difference between the value of an earlier pixel in the row and a subsequent adjacent pixel exceeds a first threshold, and determining that a difference between a value of a later pixel in the row that is within a predetermined range of the earlier pixel and a value of a pixel subsequent to the later pixel exceeds the first threshold. Moreover, in some embodiments detecting a spike includes determining spike columns, wherein spike columns are the columns associated with the earlier pixel in the row, the later pixel in the row, or the pixels in the row between the earlier pixel and the later pixel, and detecting a hit further includes determining that the spike columns of the rows within the predetermined row range that each include a spike are within a predetermined column range.

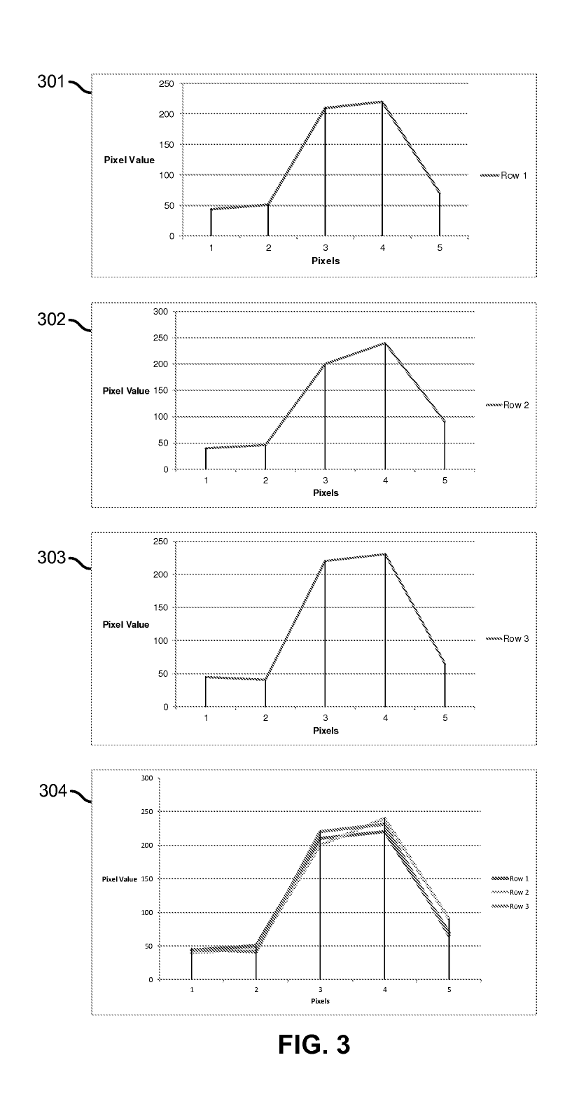

The flow then proceeds to block 230, where spikes are detected in adjacent (nearby) or adjoining (abutting) rows of pixels, and then to block 240, where a hit is detected. In some embodiment, detecting a hit includes determining that a number of rows within a predetermined row range each include a spike. The number of spikes and the number of rows within the row range that include a spike (a “row check”) are configurable parameters. Also, a threshold may define a maximum number of adjacent or adjoining rows that must have a spike to register as a hit. Otherwise, in some embodiments or circumstances, if the maximum threshold of adjacent or adjoining rows with spikes is exceeded, then an edge or line that extends across the entire image may be detected as a spike, and most text edges or lines do not extend across an entire image. FIG. 3 illustrates examples of changes in pixel values. In FIG. 3, the graphs show three rows of an image in which the pixel values, which are grayscale values, change. The first row is shown in graph 301, the second row is shown in graph 302, the third row is shown in graph 303, and all three rows are shown in graph 304. In all three rows, from pixel 1 to pixel 5, the grayscale values of the three rows range from less than 50 to between 200 and 250. Also, all three rows include a spike from pixels 2 to 5, as shown by graph 304. The spikes may indicate the presence of text at the particular location in the image. However, high contrast images may have these changes, which can be falsely detected as text. But sometimes high contrast images will need to be encoded using a high quality codec to minimize distortion.

Also for example, if a hit required four spikes, then alone each of the three spikes shown in graph 304 would not register as a hit. However, if three spikes were required for a hit, then together the three spikes shown in graph 304 would register as a hit (assuming the rows were within a required row range, for example if the three rows are three adjoining rows, and assuming the number of adjacent or adjoining rows with spikes does not exceed a maximum threshold).

After block 240, the flow proceeds to block 250, where it is determined if the number of hits exceeds a hit threshold. If yes (block 250=yes), then the flow proceeds to block 260, where the image or the region of the image is identified as text. If not (block 250=no), then the flow proceeds to block 270, where it is determined if the entire region or the entire image has been examined. If not (block 270=no), then the flow returns to block 220, where another row, which may be at least a predetermined distance from any previously detected hit, is examined for spikes. If yes (block 270=yes), then the flow proceeds to block 280, where the region or the image is identified as graphics.

Therefore, depending on the embodiment of the system or method, one or more of the following parameters are adjustable: Row Check (“Y”): This value defines the number of adjacent or adjoining rows that must have a spike to register a hit. Row maximum threshold: The maximum number of adjacent or adjoining rows that may have spikes to register a hit. Column Check (“X”): This value defines the spike width or the distance (e.g., in maximum number of columns) from a partial spike (e.g., an increase in value or a decrease in value) in which another partial spike must be found. Column threshold: The range of columns in which spikes in adjacent or adjoining rows must be found for the spikes to be counted towards a hit. Rows to skip (“Z”): This value defines the number of rows to be skipped during the check after each row. Spike threshold (“N”): This value defines the minimum difference between two adjacent pixel values for a partial spike to be detected. Hit threshold (“MAXHITS”): This value defines the number of hits that must be detected in the image or region before it is identified as a text image or a high quality image.

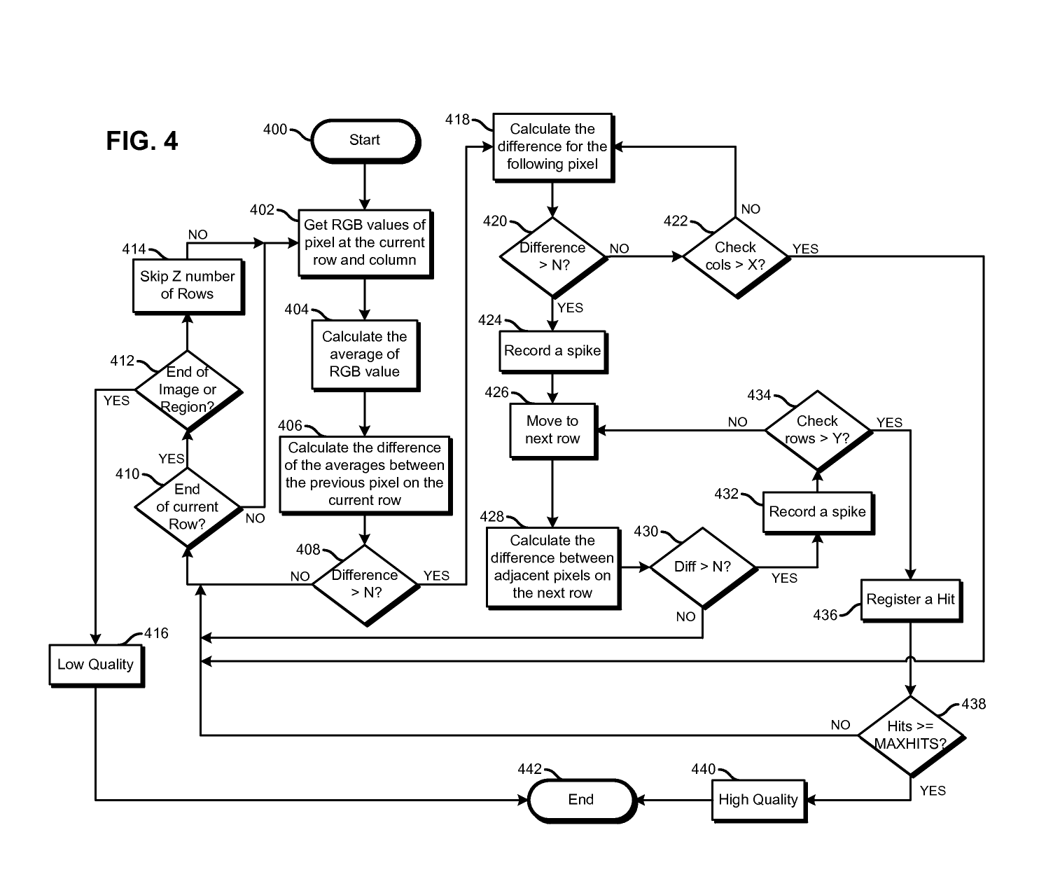

FIG. 4 illustrates an example embodiment of a method for quantifying an image. The method starts in block 400, where an image, or a region of an image, is obtained, and then proceeds to block 402. In block 402, the RGB values of the current pixel (the pixel at coordinates row R and column C) are obtained. Next, in block 404, the average of the RGB values is calculated. Then in block 406, the difference between the average of the current pixel C and the average of the previous pixel C−1 in the row is calculated.

The flow then proceeds to block 408, where it is determined if the difference exceeds the spike threshold N. If not (block 408=no), then the flow proceeds to block 410, where it is determined if the current pixel is located at the end of its row. If not (block 410=no), then the current pixel is changed to the next pixel (e.g., C=C+1), and the flow returns to block 402. If yes (block 410=yes), then the flow proceeds to block 412. In block 412, it is determined if the end of the image or the region has been reached. If yes (block 412=yes), then the flow proceeds to block 416, where the image or region is determined to be graphics or a low quality encoder is selected, and then the flow then ends in block 442. If not (block 412=no), then the flow moves to block 414. In block 414, C is reset (e.g., C=1) and Z number of rows are skipped (e.g., R=R+Z). The flow then returns to block 402.

However, if in block 408 it is determined that the difference does exceed the spike threshold N (block 408=yes), then a partial spike has been found and the flow moves to block 418 and i is set to 1. In block 418, the difference between the pixel C and the following pixel C+i is calculated, then in block 420 it is determined if the difference is greater than the spike threshold N. If not (block 420=no), then the flow proceeds to block 422, where i is incremented (e.g., i++) and it is determined if i is greater than the column check X. If not (block 422=no), then the flow returns to block 418. If yes (block 422=yes), or if the end of the row has been reached, then the flow proceeds to block 410.

If in block 420 it is determined that the difference is greater than the spike threshold N (block 420=yes), then a partial spike has been found and the flow proceeds to block 424, where a spike is recorded and a row counter j is set to 1. The flow then proceeds to block 426, where the operations move to the next row (e.g., R+1). Then in block 428, the differences between the adjacent pixels in the next row are calculated, and in block 430 it is determined if the differences are greater than the spike threshold N, which indicates if the next row has a spike (e.g., two partial spikes). If not (block 430=no), then the flow moves to block 410. If yes (block 430=yes), then the flow proceeds to block 432. In block 432, another spike is recorded and the row count is incremented (j++), and the flow then moves to block 434, where it is determined if the number of rows with a hit, j, is greater than the row check Y. If not (block 434=no), then the flow returns to block 426. If yes (block 434=yes), then the flow proceeds to block 436, where a hit is registered. Next, in block 438, it is determined if the number of hits is equal to or greater than the hit threshold MAXHITS. If not (block 438=no), then the flow moves to block 410. If yes (block 438=yes), then the flow proceeds to block 440, where the image or region is identified as text or a high quality encoder 440 is selected. The flow then ends in block 442.

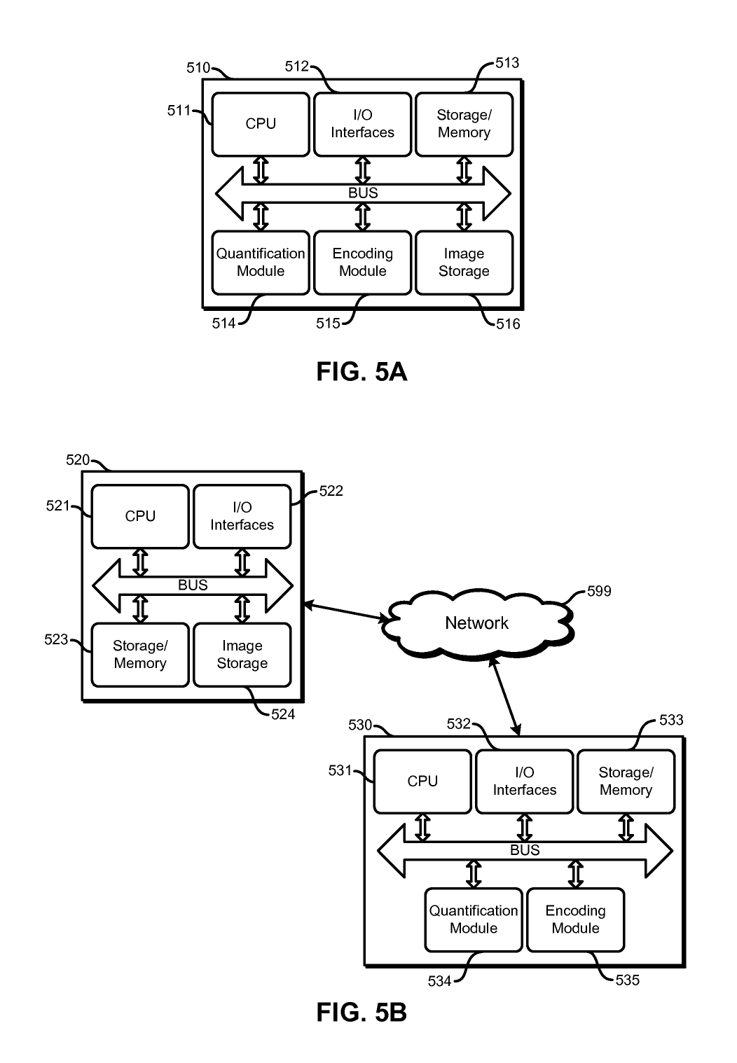

FIG. 5A illustrates an example embodiment of an image quantification system. The system includes an image quantification device 510. The image quantification device 510 includes a processor (CPU) 511, one or more I/O interfaces 512, storage/memory 513, and image storage 516. The CPU 511 includes one or more central processing units, which include microprocessors and other circuits (e.g., a single core microprocessor, a multi-core microprocessor), and is configured to read and perform computer-executable instructions, such as instructions stored in storage, in memory, or in modules. The computer-executable instructions may include those for the performance of the methods described herein. The one or more I/O interfaces 512 provide communication interfaces to input and output devices, which may include a keyboard, a display, a mouse, a printing device, a touch screen, a light pen, an optical storage device, a scanner, a microphone, a camera, a drive, and a network (either wired or wireless).

The storage/memory 513 includes one or more computer-readable or computer-writable media, for example a computer-readable storage medium or a transitory computer-readable medium. A computer-readable storage medium is a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid state drive, SRAM, DRAM, EPROM, EEPROM). A transitory computer-readable medium, for example a transitory propagating signal (e.g., a carrier wave), carries computer-readable information. The storage/memory 513 is configured to store computer-readable data or computer-executable instructions. Also, image storage 516 includes one or more computer-readable media that are configured to store images. The components of the image quantification device 510 communicate via a bus.

The image quantification device 510 also includes a quantification module 514 and an encoding module 515. Modules include logic, computer-readable data, or computer-executable instructions. Modules may be implemented in software (e.g., Assembly, C, C++, C#, Java, BASIC, Perl, Visual Basic) or firmware stored on one or more computer-readable media, in hardware (e.g., customized circuitry), or in a combination of software and hardware. In some embodiments, the image quantification device 510 includes additional or fewer modules, the modules are combined into fewer modules, or the modules are divided into more modules. Though the computing device or computing devices that execute the instructions that are stored in a module actually perform the operations, for purposes of description a module may be described as performing operations. The quantification module 514 includes instructions that, when executed by the image quantification device 510, cause the image quantification device 510 to detect spikes in rows in an image or a region of an image, detect hits in an image or a region of an image, adjust an image (e.g., adjust color depth, convert to grayscale) or a region of an image, identify an image or a region of an image as text or graphics, or select an encoder for an image. The encoding module 515 includes instructions that, when executed by the image quantification device 510, cause the image quantification device 510 to encode an image. The encoding module 515 may include instructions that implement different encoding techniques or algorithms, for example, instructions optimized for encoding text images or instructions optimized for encoding graphics images.

FIG. 5B illustrates an example embodiment of an image quantification system. The system includes an image storage device 520 and an image quantification device 530, which communicate via a network 599. For example, the image quantification device 530 can obtain images from the image storage device 520 via the network 599. The image storage device 520 includes one or more CPUs 521, one or more I/O interfaces 522, storage/memory 523, and image storage 524. The image quantification device 530 includes one or more CPUs 531, one or more I/O interfaces 532, storage/memory 533, a quantification module 534, and an encoding module 535.

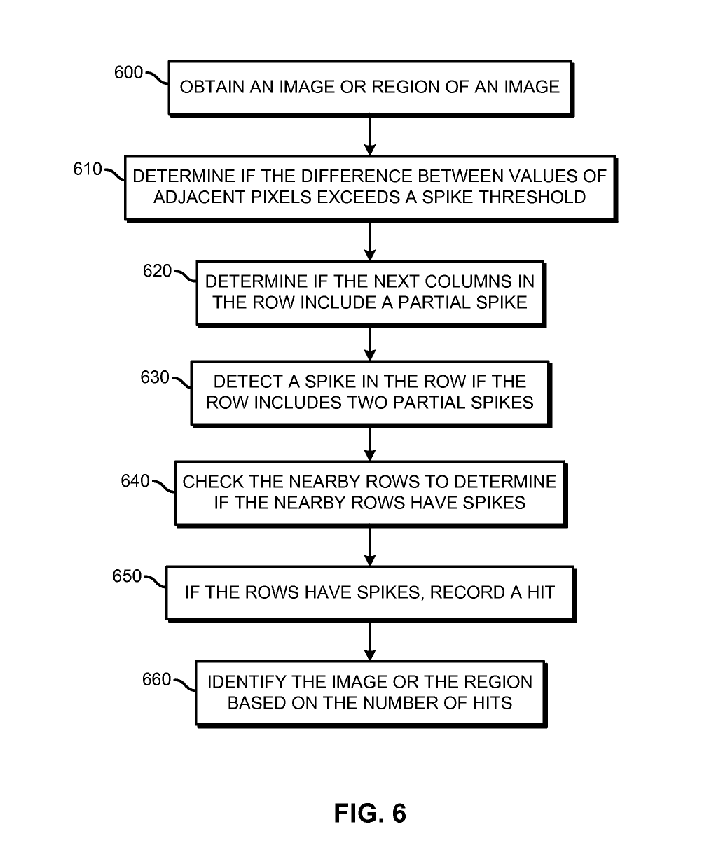

FIG. 6 illustrates an example embodiment of a method for quantifying an image. The flow starts in block 600, where an image or a region of an image is obtained. Next, in block 610, it is determined if the difference between the values of adjacent or adjoining pixels exceeds a spike threshold. The flown moves to block 620, where it is determined if the next columns in the row (e.g., within X) include a partial spike. Following, in block 630, a spike is detected in the row if the row includes two partial spikes.

The flow then moves to block 640, where the nearby rows are checked to determine if the nearby rows have spikes. The spikes (or partial spikes) in the nearby rows may need to be within a set range of each other (e.g., 2 columns, 4 columns). This may indicate an edge in the pixels that extends across the rows, instead of disjointed spikes. If enough nearby rows have spikes, then a hit is recorded in block 650. Finally, in block 660, the image or the region is identified as text or graphics based on the number of hits.

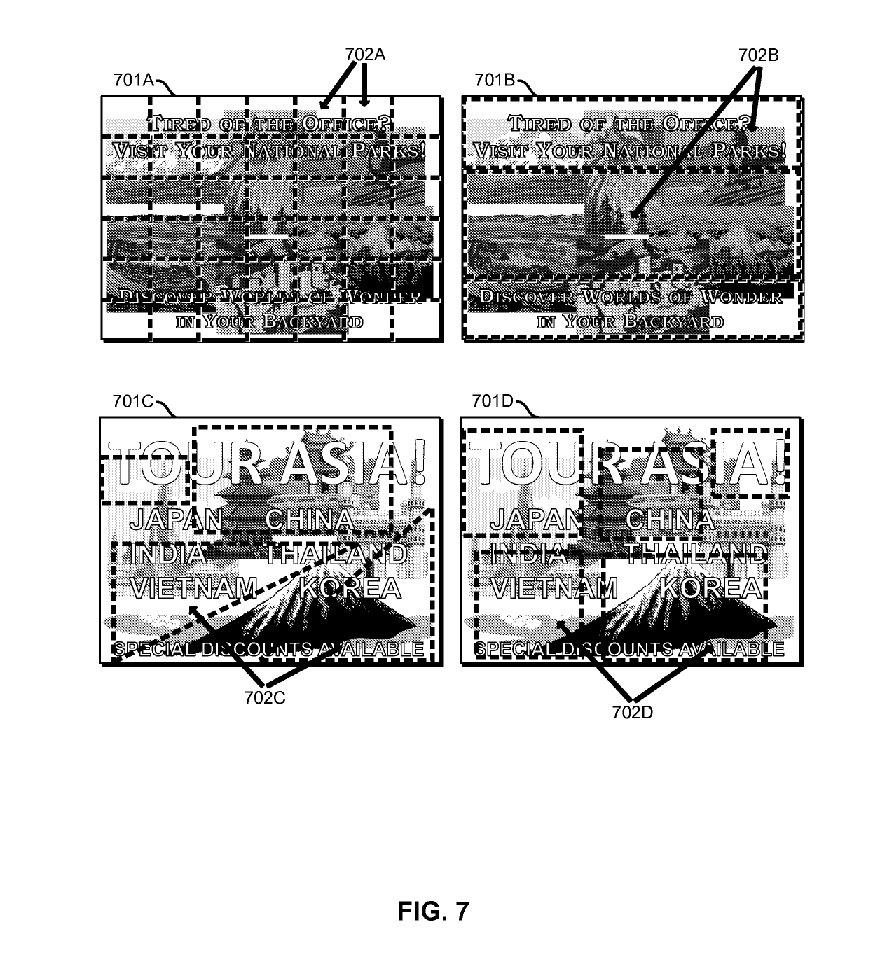

FIG. 7 illustrates example embodiments of image regions. A first image 701A includes regions 702A, which are arranged in a grid pattern. A second image 701B includes regions 702B, which are arranged based on edges in the image to approximate the locations of text in the image. The regions 702C in a third image 701C and the regions 702D in a fourth image 701D are arranged differently and include various shapes and sizes of regions.

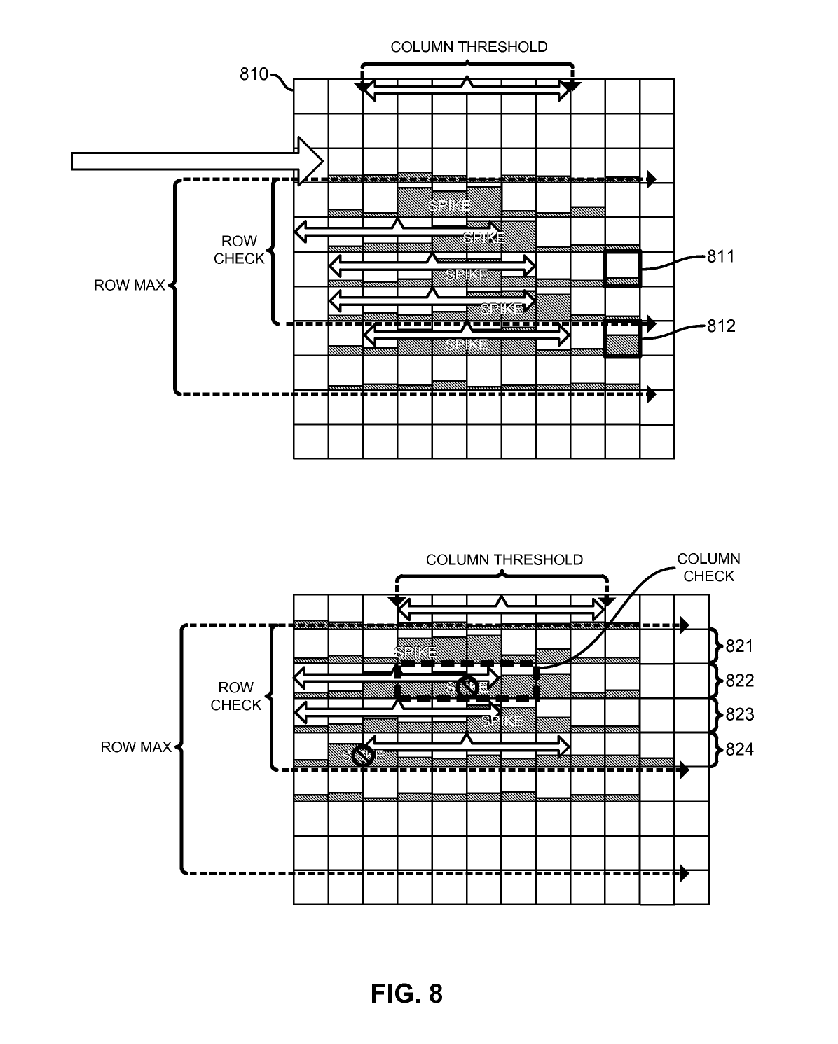

FIG. 8 illustrates examples of pixel values and spike detection. A first region 810 of an image includes pixels, and the grayscale values of certain pixels are indicated by graphs in the pixels. For example, for a first pixel 811, if the graph shows a scale of 0 to 255, where no gray fill=0 and a complete gray fill=255, the grayscale value of the first pixel is approximately 60. Also for example, the grayscale value of a second pixel 812 is approximately 150. Additionally, for the first region 810 the row check Y is 4, the row maximum threshold is 6, the column check X is 4, the column threshold is ±3, and the rows to skip Z is 0. Because the first region 810 includes five consecutive rows that have spikes, because all of the spikes count towards a hit, and because the row check Y is 4, a hit is registered for the first region 810.

A second region 820 also includes rows that have spikes. However, some of the rows do not include changes in pixel values that register as spikes. For example, in a second row 822, a partial spike is detected, and the partial spike is followed by another partial spike. However, the second partial spike's position is outside of the column check, which is 4 in this example. Thus, the partial spikes in the second row 822 do not register as a spike. Also, a fourth row 824 includes a first partial spike and a second partial spike, and the second partial spike is located within the column check, which is 4. However, the second partial spike is located outside the column threshold of ±3, so the partial spikes in the fourth row 824 do not register as a spike. Note that in this embodiment the column threshold is defined from the previous spike, which is in the third row 823, not from the first spike that is detected in the region, which is in the first row 821. Therefore, even though the partial spikes in the fourth row 824 are within ±3 columns of the first partial spike in the first row 821, in this embodiment the partial spikes in the fourth row 824 do not register as a spike. Therefore, a hit is not detected in the second region 820.

The above-described devices, systems, and methods can be implemented by supplying one or more computer-readable media that contain computer-executable instructions for realizing the above-described operations to one or more computing devices that are configured to read the computer-executable instructions and execute them. The systems or devices perform the operations of the above-described embodiments when executing the computer-executable instructions. Also, an operating system on the one or more systems or devices may implement at least some of the operations of the above-described embodiments. Thus, the computer-executable instructions or the one or more computer-readable media that contain the computer-executable instructions constitute an embodiment.

Any applicable computer-readable medium (e.g., a magnetic disk (including a floppy disk, a hard disk), an optical disc (including a CD, a DVD, a Blu-ray disc), a magneto-optical disk, a magnetic tape, and a solid state memory (including flash memory, DRAM, SRAM, a solid state drive, EPROM, EEPROM)) can be employed as a computer-readable medium for the computer-executable instructions. The computer-executable instructions may be stored in a computer-readable storage medium provided on a function-extension board inserted into the device or on a function-extension unit connected to the device, and a CPU provided on the function-extension board or unit may implement the operations of the above-described embodiments.

The scope of the claims is not limited to the above-described embodiments and includes various modifications and equivalent arrangements.

What is claimed is:

1. A method for evaluating a quantity of text in an image, the method comprising:
determining rows in an image that include spikes, wherein determining that a row includes a spike includes
determining that a difference between the value of an earlier pixel in the row and a subsequent adjacent pixel exceeds a first threshold, and
determining that a difference between a value of a later pixel in the row that is within a first predetermined range of the earlier pixel and a value of a pixel subsequent to the later pixel exceeds the first threshold;
determining a number of hits in the image, wherein determining a hit includes determining that a number of rows within a predetermined row range each include a spike;
determining if the number of hits exceeds a second threshold; and
selecting an image encoder based on whether or not the number of hits exceeds the threshold.

2. The method of claim 1, wherein
determining a spike further includes determining spike columns, wherein spike columns are the columns associated with the earlier pixel in the row, the later pixel in the row, and the pixels in the row between the earlier pixel and the later pixel; and
determining a hit further includes determining that the spike columns of the rows within the predetermined row range that each include a spike are within a predetermined column range.

3. The method of claim 1, further comprising converting pixels values in the image to grayscale values.

4. The method of claim 1, further comprising receiving a user selection of one or more of the first predetermined range, the first threshold, the predetermined row range, and the second threshold.

5. The method of claim 1, wherein the number of rows within the predetermined row range are less than the predetermined row range.

6. The method of claim 1, wherein the number of rows within the predetermined row range are equal to the predetermined row range.

7. The method of claim 1, wherein a hit must be separated from another hit by a predetermined hit distance.

8. A device for evaluating an image, the device comprising:
one or more computer-readable media configured to store an image; and
one or more processors coupled to the one or more computer-readable media and configured to cause the device to
detect a spike in a row of pixels in a region of an image,
detect respective spikes in adjacent rows of pixels,
register a hit if the spikes are within a predetermined row range of each other, and
determine the number of hits in the region of the image.

9. The device of claim 8, wherein the processors are further configured to select an image encoder for the region of the image based on the number of hits.

10. The device of claim 8, wherein detecting a spike includes determining that a difference between the value of an earlier pixel in the row and a subsequent adjacent pixel exceeds a first threshold, and determining that a difference between a value of a later pixel in the row that is within a first predetermined range of the earlier pixel and a value of a pixel subsequent to the later pixel exceeds the first threshold.

11. The method of claim 8, wherein determining a hit includes detecting within a predetermined area in the region of the image at least a number of spikes equal to a hit threshold

12. The method of claim 8, wherein a hit must be at least a minimum distance from all other hits.

13. One or more computer-readable media storing instructions that, when executed by one or more computing devices, cause the computing devices to perform operations comprising:
detecting spikes in rows of a region of an image;
detecting a number of hits in the image;
determining if the number of hits exceeds a second threshold; and
selecting an image encoder based on whether or not the number of hits exceeds the threshold.

14. The one or more computer-readable media of claim 13, wherein detecting a spike includes detecting that a difference between the value of an earlier pixel in the row and a subsequent adjacent pixel exceeds a first threshold.

15. The one or more computer-readable media of claim 14, wherein detecting a spike further includes detecting that a difference between a value of a later pixel in the row that is within a first predetermined range of the earlier pixel and a value of a pixel subsequent to the later pixel exceeds the first threshold;

16. The one or more computer-readable media of claim 13, wherein detecting a hit includes determining that a number of rows within a predetermined row range each include a spike.

17. The one or more computer-readable media of claim 13, wherein the operations further comprise converting colors in the region of the image to grayscale colors.
